(19) United States
(12) Patent Application Publication
(10) Pub. No.: US 2018/0032921 A1
(43) Pub. Date: Feb. 1, 2018

(54) COMMUNICATION SYSTEM INCLUDING SERVER CONFIGURED FOR EVENT MANAGEMENT

(71) Applicant: Rita Hopper, Arlington, VA (US)

(72) Inventor: Rita Hopper, Arlington, VA (US)

(21) Appl. No.: 15/665,192

(22) Filed: Jul. 31, 2017

Related U.S. Application Data
(60) Provisional application No. 62/369,226, filed on Aug. 1, 2016.

(51) Int. Cl. G06Q 10/02; G06Q 10/06; G06Q 10/04

(52) U.S. Cl. CPC G06Q 10/02; G06Q 10/04; G06Q 10/06311; G06Q 10/06314

(57) ABSTRACT

A method in a computing device in a communication system is described herein. An event indication corresponding to an event is received from a host user device of an event host. A list of potential guests for the event is determined and event information is transmitted to users in the list of potential guests. One or more reservation requests is received from guest user devices of one or more users in the list of potential guests in response to the transmitted event information and transmitted to the host user device. One or more indications of acceptances or rejections of each of the one or more reservation requests is received from the host user device by the event host. A list of booked guests is determined to include one or more users from the list of potential guests based at least in part on the received indications of acceptances or rejections.

### CROSS-REFERENCE TO RELATED APPLICATION

This application claims priority to U.S. Provisional Patent Application No. 62/369,226, filed Aug. 1, 2016 and entitled “Combination Social Media Platform and Reservation System for Event Hosting and Attendance,” the entirety of which is incorporated by reference herein.

### BACKGROUND OF THE INVENTION

### Technical Field

The subject matter described herein relates to a communication system for communicating information with regard to an event.

### Description of Related Art

Social media platforms are commonly used as a communication tool between users thereof. It is common for users engaging in activity on a social media platform to desire to invite other users to events. This may be inconvenient, as the users may need to switch to a different application from an application of the social media platform in order to generate and provide the invitations.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, computing devices, and computer program products are provided for communications in a communication system to coordinate an event. An event indication corresponding to an event is received from a host user device operated by an event host, the event indication including event details that include at least an event location. A list of potential guests for the event is determined from a plurality of users. Event information containing at least a portion of the event details is transmitted to users in the list of potential guests to enable each user in the list of potential guests to access the event information on a respective guest user device. One or more reservation requests are received from guest user devices of one or more users in the list of potential guests in response to the transmitted event information. The one or more reservation requests are transmitted to the host user device. One or more indications of acceptances or rejections of each of the one or more reservation requests is received from the host user device by the event host. A list of booked guests (also referred to as an “event guest list”) is determined to include one or more users from the list of potential guests based at least in part on the received indications of acceptances or rejections.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a communication system in which events are coordinated via communications of event information, according to an embodiment.

FIG. 2 shows a flowchart for event coordination in a communication system, according to an example embodiment.

FIG. 3A shows a block diagram of an event coordinator, according to an example embodiment.

FIG. 3B shows a block diagram of an event booking application, according to an example embodiment.

FIGS. 4A-4D shows a block diagram of a communication system in which information is communicated to coordinate an event, according to an example embodiment.

FIG. 5 shows a block diagram of a communication system in which event-related messaging of information is communicated, according to an example embodiment.

FIG. 6 shows a flowchart for transmitting a booking indication, according to an example embodiment.

FIG. 7A shows a flowchart for receiving an event status indication, according to an example embodiment.

FIG. 7B shows another flowchart for receiving an event status indication, according to an example embodiment.

FIG. 8 shows a flowchart for determining a list of potential guests, according to an example embodiment.

FIG. 9 shows a flowchart for generating a host guest list based on communicated information, according to an example embodiment.

FIG. 10 shows another flowchart for generating a host guest list based on communicated information, according to an example embodiment.

FIG. 11 shows another flowchart for determining a list of potential guests, according to an example embodiment.

FIG. 12 shows a flowchart for transmitting a calendar appointment for the event, according to an example embodiment.

FIG. 13 shows a flowchart for enabling users to contact the event host, according to an example embodiment.

FIG. 14A shows a flowchart for enabling the event host to rate a user who attended the event, according to an example embodiment.

FIG. 14B shows a flowchart for enabling the user who attended the event to rate the event host, according to an example embodiment.

FIG. 15 shows a flowchart for transmitting event information regarding multiple events from hosts to users, according to an example embodiment.

FIG. 16 shows a flowchart depicting interactions between host and guest users, according to an example embodiment.

FIG. 17 shows a flowchart depicting an interface usage flow for host and guest users, according to an example embodiment.

FIG. 18 shows a flowchart depicting an interface usage flow for host and guest users, further to the flowchart of FIG. 17, according to an example embodiment.

FIG. 19 is a block diagram of an example processor-based system that may be used to implement various embodiments described herein.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### II. Example Embodiments

Social media platforms are commonly used as a communication tool between users thereof. It is common for users to desire to invite other users to events while engaging in activity on a social media platform. This may be inconvenient, as the users may need to switch to a different application from an application of the social media platform in order to invite the users.

Typically, to schedule an event using a conventional application, a host user sends an invitation for the event to guest users the host user specifies in the invite, and awaits RSVPs from each of the guest users. The host user usually includes various pieces of information regarding the event in the invitation, such as the date, time, location, and type. Through the application, the host user may view a list of guest users that indicated they would attend the event.

To RSVP to the event, a guest user receives the invitation from the host user and either accepts or rejects the invitation. In the invitation, a guest user typically can see how many other users are invited and their identities, as well as being enabled to determine which guest users have accepted the invitation. This may create an issue for the host, because a guest user may decide to wait until the last minute to RSVP to the event based on who else is attending or at their own prerogative, so the host may not know who all is attending the event until the actual event time arrives. If there is a cost for attending the event, an attending guest user typically needs to submit the payment through a different application than application used to schedule the event.

Embodiments overcome these and other issues related to event scheduling. In embodiments, a communication system includes an event coordinator that communicates with a host user device and multiple guest user devices to enable a host user to post and manage an event, including managing the attending guest users, in a novel fashion.

The event coordinator is configured to receive an event indication including event details inputted by a host user at a host user device, and to transmit the event information to particular guest user devices of potential guests. The event coordinator determines the guest user devices of users that should receive the event information (as potential attendees), and transmits the event information to the determined guest user devices. The determined gust users/guest user devices may include all of those available or a subset thereof. Guest users that are available may include those searching for events occurring around the guest user's actual location or profile-indicated location.

The event coordinator enables guest users who receive the event information to transmit a reservation request to attend the event to the host user device via the event coordinator. The host user can accept or reject a received reservation request, and in response to an acceptance of the reservation request for a particular guest, that guest user becomes a booked guest on the host user's booked guest list for the corresponding event. The event coordinator keeps track of the booked guest list for the host user while still allowing the host user to accept or reject a reservation request from further guest users.

In an embodiment, the event information transmitted to the potential guests does not include the event location until a guest user has been added to the booked guest list, thereby keeping the event location private until that time. The event coordinator does not enable potential guests to determine the other guests that are attending or the number of guests attending, thereby discouraging guest users from making last minute acceptances. A guest user that is a confirmed guest may be enabled to pay for the event via the event coordinator.

Accordingly, the event coordinator enables event scheduling and hosting in a manner very different from conventional techniques. For instance, instead of the conventional technique of transmitting an event invitation to a specified list of guest users, and awaiting their acceptances, the event coordinator enables a host user to generate an event, posts the event to a group of potential guests, enables each potential guest to respond with a reservation request if the potential guest desires to attend the event, and the host accepts or rejects the reservation requests, with each of these communications handled by the event coordinator (e.g., at a server). Thus, the event coordinator provides technical benefits, including providing a host with more precise control over a number of attending guests to an event (e.g., by accepting/rejecting guests having provided reservation requests, and therefore highly likely to be interested and available for the event), enabling a host to more completely fill an event to capacity (by accepting a number of guests having provided a reservation request equal to the number of spaces in the event), and encouraging early acceptance of the event by guests (e.g., by hiding from the users indications of guests that have already accepted so the users cannot wait to see who accepts, and/or by posting the event information to a number of users greater than the actual number of available event spaces, so that the earlier a reservation request is submitted by a user, the more chance the user has of being accepted by the host), etc. Furthermore, processor power, communications mechanisms, and memory are conserved by embodiments. For instance, processing and communicating resources are saved for guest users with a high likelihood of attendance (due to their transmitting reservation requests) rather being expended on a pool of invitees that includes persons who may not even desire to/plan to attend, as in convention techniques. Furthermore, memory resources are saved by storing information for an event related to guests who indicated interest in attending by transmitting a reservation request, rather than storing information related to a pool of invitees that includes person who may not even desire to/plan to attend, as in conventional techniques.

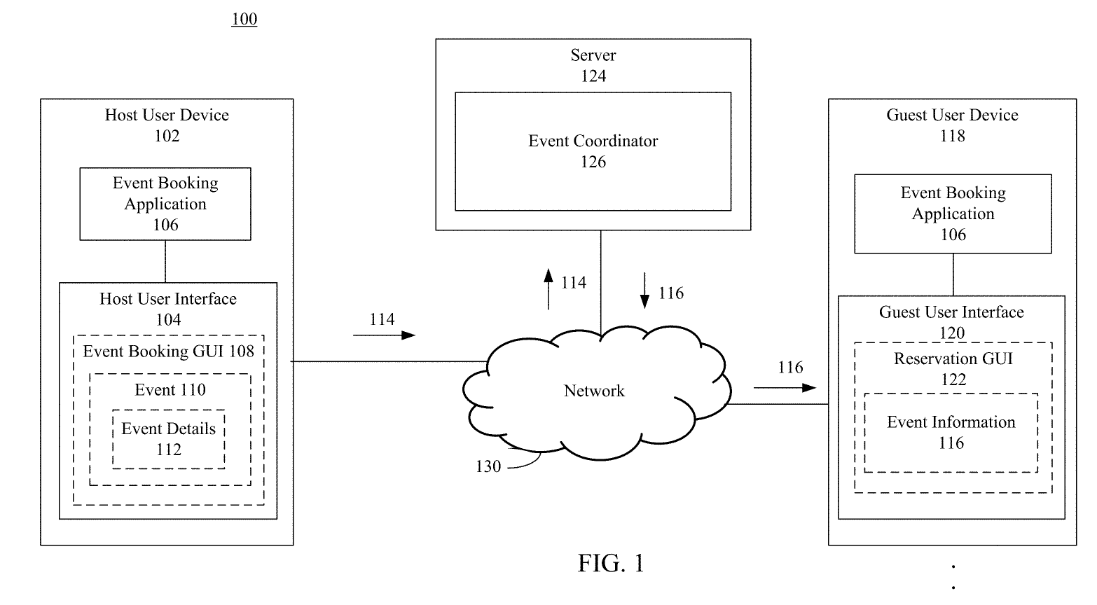

Example embodiments are described as follows directed to techniques for event coordination in a communication system. For instance, FIG. 1 shows a block diagram of a communication system 100 for coordinating events, according to an example embodiment. As shown in FIG. 1, communication system 100 includes a host user device 102, one or more guest user devices 118, and a server 124. Server 124 includes an event coordinator 126. Host user device 102 includes a first event booking application 106. Guest user device 118 includes a second event booking application 106. Host user device 102, guest user device 118, and event coordinator 126 are communicatively coupled via a network 130. These features of system 100 are described as follows.

Host user device 102 and guest user device 118 may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a Blackberry® device, etc.), a wearable computing device (e.g., a smart watch, a head-mounted device including smart glasses such as Google® Glass™ etc.), or other type of mobile device (e.g., an automobile), or a stationary computing device such as a desktop computer or PC (personal computer). Still further, client device 102 may be a portable media player, a stationary or handheld gaming console, a personal navigation assistant, a camera, or other type of stationary or mobile device. Although a single host user device 102 and a single guest user device are shown in FIG. 1, in other embodiments, other numbers of host user and guest user devices may be present in system 100, including tens, hundreds, thousands, and greater numbers.

Servers 124 may be formed of one or more computing devices that enable communications between devices and/or that are capable of serving information and/or providing other services. Server 124 may include any number of individual server devices, including tens, hundreds, and thousands of servers. Each of host user device 102, guest user device 118, and server 1248 may include at least one network interface that enables communications over network 130. Network 130 may comprise one or more networks such as local area networks (LANs), wide area networks (WANs), enterprise networks, the Internet, etc., and may include one or more of wired and/or wireless portions.

Event booking applications 106 in host user device 102 and in guest user device 118 are each instances of an application (e.g., implemented in computer code executed by a processor, programmed according to any suitable programming language and/or scripting language, such as C++, C#, HTML (hypertext markup language), JavaScript, etc.) configured to communicate with event coordinator 126, and to provide a user interface for a host user and/or a guest user at the corresponding device. In the example of FIG. 1, event booking applications 106 in host user device 102 and in guest user device 118 are instances of the same application, which is configured with both a host interface and a guest interface. In another embodiment, different types of event booking application 106 may be present, with a first instance configured with a host user interface (for use by host users), and a second instance configured with a guest user interface (for use by guest users).

In an embodiment, a user (“host user”) of host user device 102 interacts with event booking application 106 to input an event 110. It should be noted that while only one event is showed in FIG. 1, the host user can input further events. As shown in FIG. 1, the host user may activate event booking application 106, which generates a host user interface 104 to enable the host user to enter event details 112 of event 110 via an event booking GUI (graphical user interface) 108. Examples of event details 112 includes an event location, an event time, an event date, an event description, an event type, and/or other information descriptive of an event. Event booking application 106 transmits an event indication 114 corresponding to event 110 to event coordinator 126. Event indication 114 contains a portion or all of event details 112. As shown in FIG. 1, event coordinator 126 receives event indication 114 and transmits event information 116 to one or more guest user devices 118 via network 130. In an embodiment, event information 116 includes a subset of event details 112. In an embodiment, and as described in more detail elsewhere herein, event coordinator 126 determines the particular guest user devices to receive event information 116.

In particular, event coordinator 126 is configured to coordinate event 110. In further detail, event coordinator 126 is configured to determine a list of potential guests to receive event information 116. As shown in FIG. 1, a guest user of guest user device 118 is selected to receive event information 116, and is enabled to activate event booking application 106 to generate a guest user interface 120, which displays event information 116 for the guest user at reservation GUI 122.

Event coordinator 126 is further configured to receive reservation requests (not shown in FIG. 1) for event 110 from guest user device 118 (and other guest user devices), and to transmit the reservation requests to host user device 102. Event coordinator 126 is further configured to receive acceptances or rejections of each of the reservation requests from host user device 102, and based on the acceptances and rejections, to determine a list of booked guests (the “event guest list”). These features of event coordinator 126 are discussed in more detail elsewhere herein.

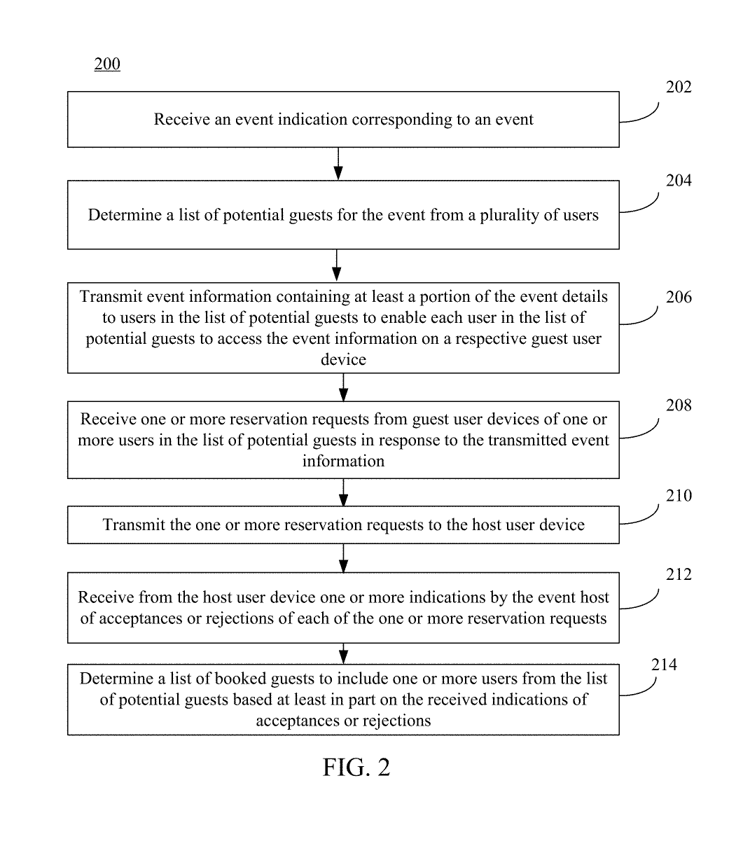

Accordingly, in embodiments, one or more events may be coordinated in a communication system between host user device 102 and one or more guest user devices 118 via event coordinator 126. Event coordinator 126 may perform this coordination in various ways. For instance, FIG. 2 shows a flowchart 200 for event coordination in communication system 100, according to an example embodiment. In an embodiment, flowchart 200 may be implemented by event coordinator 126. FIG. 2 is described as follows with continued reference to system 100 in FIG. 1. Other structural and operational embodiments will be apparent to persons skilled in the relevant art(s) based on the following discussion regarding flowchart 200 and system 100.

Flowchart 200 begins with step 202. In step 202, an event indication corresponding to an event is received. For example, with reference to FIG. 1, event coordinator 126 receives event indication 114 from host user device 102. Event indication 114 includes event details 112 of event 110 input by a host user that include at least an event location of the event.

In step 204, a list of potential guests is determined for the event from a plurality of users. For instance, with reference to FIG. 1, event coordinator 126 determines that guest user device 118 is included in the list of potential guests. Event coordinator 126 may determine the list of potential guests for event 110 in various ways, including by including all users of application 106, by including all users of application 106 within a predetermined distance of the event location, by including all users in a host guest list maintained by the host user, and/or in another manner described elsewhere herein.

In step 206, event information containing at least a portion of the event details is transmitted to users in the list of potential guests to enable each user in the list of potential guests to access the event information on a respective guest user device. For example, with reference to FIG. 1, event coordinator 126 transmits event information 116 to guest user of guest user device 118. The guest user of guest user device 118 can access event information 116 via reservation GUI 122 of guest user interface 120 generated by event booking application 106.

In step 208, one or more reservation requests are received from guest user devices of one or more users in the list of potential guests in response to the transmitted event information. For instance, with continued reference to FIG. 1, in response to viewing event information 116, the guest user of guest user device 118 transmits a reservation request to event coordinator 126 which receives the reservation request. The reservation request indicates that the guest user desires to attend event 110.

In step 210, the one or more reservation requests are transmitted to the host user device. For instance, with reference to FIG. 1, event coordinator 126 transmits the reservation request received from the guest user of guest user device 118 (and those received from other guest user devices) to host user device 102.

In step 212, one or more indications by the event host of acceptances or rejections of each of the one or more reservation requests are received from the host user device. For instance, with reference to FIG. 1, event coordinator 126 receives an acceptance or rejection from the host user of host user device 102 of the reservation request submitted by the guest user of guest user device 118 (as well as receiving acceptances/rejections of any further reservation requests).

In step 214, a list of booked guests is determined to include one or more users from the list of potential guests based at least in part on the received indications of acceptances or rejections. For instance, and with reference to FIG. 1, event coordinator 126 determines a list of booked guests based on the acceptances and rejections received from the host user of host user device 102 regarding the reservation requests. For example, if host user of host user device 102 accepts the reservation request received from the guest user of guest user device 118, this acceptance is transmitted from host user device 102 to event coordinator 126, and event coordinator 126 indicates that the guest user of guest user device 120 is a booked guest in the list of booked guests. Alternatively, if the host user of host user device 102 rejects the reservation request of the guest user of guest user device 118, event coordinator 126 receives an indication of this rejection, and does not include the guest user of guest user device 118 in the list of booked guests.

As described above, an event coordinator, such as event coordinator 126 of FIG. 1, coordinates a host user's event in a communication system. Such an event coordinator may be configured in various ways, and may perform its functions in various ways.

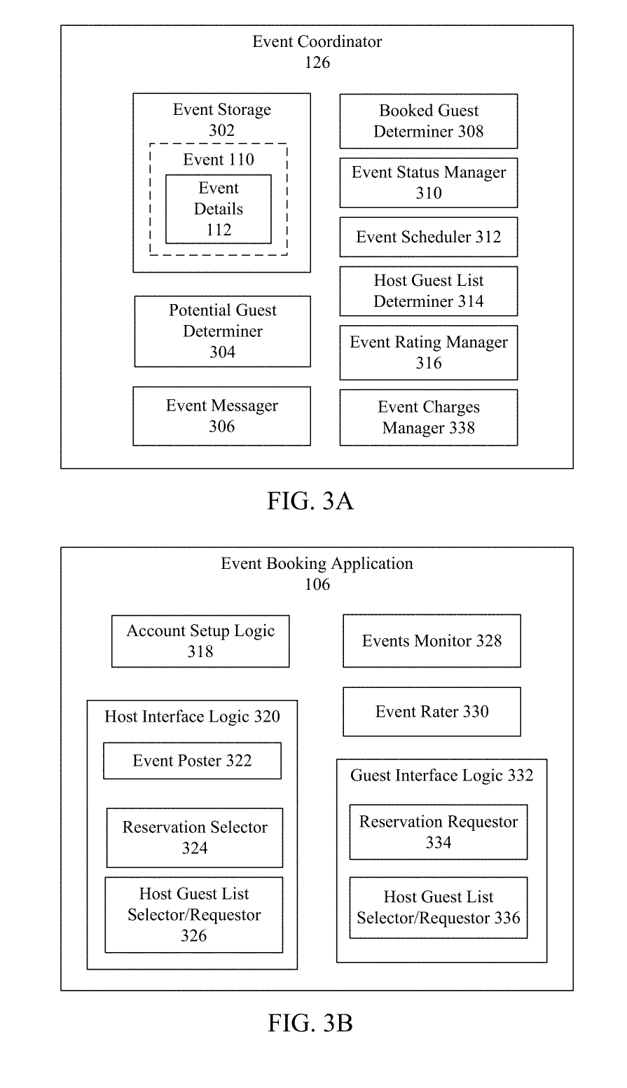

For instance, FIG. 3A shows a block diagram of an example embodiment of event coordinator 126 of FIG. 1. As shown in FIG. 3A, event coordinator 126 includes event storage 302, a potential guest determiner 304, an event messager 306, a booked guest determiner 308, an event status manager 310, an event scheduler 312, a host guest list determiner 314, an event rating manager 316, and an event charges manager 338. Not all of the components of event coordinator 126 shown in FIG. 3A need be present in all embodiments. These components of event coordinator 126 are described as follows.

Event storage 302 is configured to store event details for events. As shown in FIG. 3A, and with continued reference to FIG. 1, event details 112 for event 110 (e.g., input to event booking GUI 108 in FIG. 1) are stored in event storage 302. Although event details for a single event are shown stored in FIG. 3A, it should be understood that event details for multiple events can be stored in event storage 302.

Potential guest determiner 304 is configured to receive an event indication of an event from a host user device and determine a list of potential guests for the event from the plurality of users. For instance, and with continued reference to FIG. 1, potential guest determiner 304 receives event indication 114 of event 110 from host user device 102

Event Messager 306 is configured to transmit event information containing at least a portion of the event details to users in the list of potential guests. For instance, as described above, when the guest user of guest user device 118 is included in the list of potential guests for event 110, event messager 310 transmits event information 116 to guest user device 118. Event messager 306 is further configured to receive reservation requests from one or more guest user devices of users in the list of potential guests in response to the transmitted event information. For instance, in response to receiving event information 116, the guest user of guest user device 118 transmits a reservation request to event messager 306 of event coordinator 126. Event messager 306 is further configured to transmit the one or more reservation requests to the host user device. In the current example, event messager 306 transmits the reservation request from guest user device 118 to host user device 102.

Event Messager 306 is further configured to enable booked guests to contact the event host. For instance, once a guest user is a confirmed and/or booked guest of an event, the host user and the guest user are enabled to communicate by event messager 306. Alternatively, if a guest user is not a confirmed and/or booked guest of an event hosted by the host user, then the host user and the guest user are prevented by event messager 306 from communicating.

Booked guest determiner 308 is configured to receive indications of acceptances or rejections of each of the one or more reservation requests from the event host. For instance, once the host user of host user device 102 receives the reservation request from guest user device 118 via event messager 306, the host user may accept or reject (via a reservation response) the reservation request and transmit the response to booked guest determiner. Booked guest determiner 308 is further configured to determine a list of booked guests to include one or more users from the list of potential guests based at least in part on the received indications of acceptances or rejections. For instance, if booked guest determiner 308 receives an acceptance of the reservation request from host user device 102 then booked guest determiner 308 adds the guest user of guest user device 118 to the list of booked guests. Alternatively, if booked guest determiner 308 receives a rejection of the reservation request from host user device 102, then booked guest determiner 308 does not add the guest user of guest user device 118 to the list of booked guests.

Event status manager 310 is configured to receive event status information from the event host at host user device 102. For example, event status manager 310 may receive an event closed indication from the event host. The host may desire to input an event closed indication (e.g., at event booking GUI 108) if the desired number of guest users have been accepted, or for another reason. In another embodiment, event status manager 310 is configured to receive an event cancellation indication from the event host. The host may desire to input an event cancellation indication (e.g., at event booking GUI 108) if a desired minimum number of guest users have not responded with reservation requests, particular desired guest users have not responded with reservation requests, due to weather, due to problems with the event location, due to illness of the host user, and/or for any other reason.

Event scheduler 312 is configured to transmit a calendar appointment for the event to each guest user device of a booked guest and to the host user device. For instance, if the guest user of guest user device 118 is a booked guest, event scheduler 316 may transmit a calendar appointment for event 110 to guest user device 118 to be input into a calendar of event booking application 106 and/or another application containing a calendar. Similarly, event scheduler 312 may transmit the calendar appointment for event 110 to host user device 102 for a calendar of the host user.

Host guest list determiner 314 is configured to determine a host user's host guest list, which is a list of users that the host may desire to invite to some future events rather than sending out a broad invitation to all available users (e.g., all users with an account with event booking application 106). In embodiments, and discussed in further detail elsewhere herein, host guest list determiner 314 adds guest users to a host guest list (a list of users preferred for events by the host over all publicly available users) in various ways. For instance, the host user device of the host user may transmit an inclusion request to one or more user devices of one or more users selected by the host user. Each user can accept or reject the inclusion request. If the user accepts the inclusion request, the user is added to the host guest list by host guest list determiner 314. If the user rejects the inclusion request, the user is not included in the host guest list.

Additionally, or alternatively, host guest list determiner 314 at the host user device may receive one or more inclusion requests from users at respective user devices to be included in the host guest list. The host can accept or reject each inclusion request. If the host user accepts the inclusion request, the user is added to the host guest list by host guest list determiner 314. If the user rejects the inclusion request, the user is not added to the host guest list. Still further, a contacts list of the host user, a “friends list” (e.g., from a social network) of the host user, and/or other similar list of people preferred by the host user, may be imported to form or to add to their host guest list.

Event rating manager 316 is configured to, after the event occurs, enable the event host and/or booked guests to provide ratings regarding the event. For instance, event rating manager 316 may receive a rating from the event host of one or more of the booked guests that attended the event (e.g., indicating whether a guest was a good guest or a bad guest, providing a rating between 1 to 5 stars, providing a “like” indication, etc.). Furthermore, event rating manager 316 may receive a rating from one or more of the booked guests of the event host (e.g., indicating whether the event host was a good host or a bad host, whether the event was enjoyable or not enjoyable, providing a rating between 1 to 5 stars, providing a “like” indication, etc.).

Event charges manager 338 is configured to manage charges made to guest users booked to attend the event. In embodiments, event charges manager 338 includes payment functionality and/or accesses an online payment application (e.g., PayPal® provided by PayPal Holdings, Inc., Apple Pay® provided by Apple Inc., Google Wallet™ or Android Pay™ provided by Google, etc.). In an embodiment, event charges manager 338 generates or provides a payment user interface displayed in reservation GUI 122 (FIG. 1) that enables guest users to provide payments, and/or generates or provides a payment management interface in event booking GUI 108 (FIG. 1) that enables host users to monitor which guests have paid and have not paid, to interact with guest users to request payments. In embodiments, guest users may pay to attend an event at one or more times or time ranges, such as the time they are booked to attend, at the time the event is held, after the event it held, and/or any other desired time. In other instances, an event may be free to attend and event charges manager 338 is inactive.

As described above, an event booking application, such as event booking application 106 of FIG. 1, enable guest users and host user to interact through event coordinator 126 to book and manage events. Such an event booking application may be configured in various ways, and may perform its functions in various ways.

For instance, FIG. 3B shows a block diagram of event booking application 106 of FIG. 1. As shown in FIG. 3B, event booking application 106 includes account setup logic 318, host interface logic 320, an events monitor 328, an event rater 330, and a guest interface logic 332. Host interface logic 320 includes an event poster 322, a reservation selector/requestor 324, and a host guest list selector 326. Guest interface logic 332 includes a reservation selector/requestor 334, and a guest list requestor 336. Not all of the components of event booking application 106 shown in FIG. 3B need be present in all embodiments. These components of event booking application 106 are described as follows.

Account setup logic 318 is configured to enable a user of a device to setup an account. For instance, host users and guest users may each set up an account with event booking application 106 by interacting with a user interface generated by account setup logic 318. The user interface may enable the user to configure an account name (e.g., login name, email address, etc.), a password, a messaging identifier (e.g., an email address, a phone number, an instant messaging identifier, etc.), profile information (e.g., a name, a photo, bio, a list of passions and/or affiliations, work details, etc.), one or more account preferences, notification methods, and/or other account information. Each account may include account details such as the payment history of the corresponding host user or guest user, terms and conditions, privacy policy, notification details and/or other account details.

Event poster 322 is configured to post an event once it is input by the host of a corresponding event. For instance, event poster 322 receives the event information for event 110 input the host of host user device 102, as described above. Event poster 322 is configured to transmit the event information in event indication 114 to event coordinator 126, as shown in FIG. 1.

Reservation selector/requestor 324 is configured to allow the host to accept or reject a received reservation request. For instance, reservation selector/requestor 324 may generate a user interface to enable the host to accept or reject a received reservation request, as described above.

Host guest list selector/requestor 326 is configured to enable host users to process requests to join host guest lists. For instance, host guest list selector/requestor 326 may generate a user interface to enable the host to accept or reject a received inclusion request, and to input an inclusion request to be transmitted to one or more guest users. After an inclusion request is received from a guest user device, the host of the host user device may accept or reject the request via host guest list selector/requestor 326.

Events monitor 328 is configured to monitor the event and update an event status accordingly. The host may be enabled to access the event status using events monitor 328. For instance, events monitor 328 may track when a booked guest is added to the booked guest list, a number of people attending, an indication of the reservation status (e.g., pending, accepted, fully booked), etc.

Event rater 330 is configured to enable the host user to rate a booked guest after the occurrence of an event. For instance, as described above with respect to event rating manager 316, the host user may rate a booked guest who attended the event, and/or a booked guest who attended the event may rate the event host by interacting with a user interface of event rater 330.

Reservation requestor 334 is configured to enable a guest user to transmit a reservation request to an event host. For instance, reservation requestor 334 of guest user device 118 may transmit a reservation request for a guest user to the host user of host user device 102 for event 110 via reservation requestor 334.

Host guest list selector/requestor 336 is configured to enable guest users to accept or reject a received inclusion request and/or transmit an inclusion request to the event host. For instance, host guest list selector/requestor 336 may generate a user interface that enables the user of guest user device to accept or reject (i.e., respond to) a received inclusion request and/or to submit an inclusion request for transmit to the host of host user device.

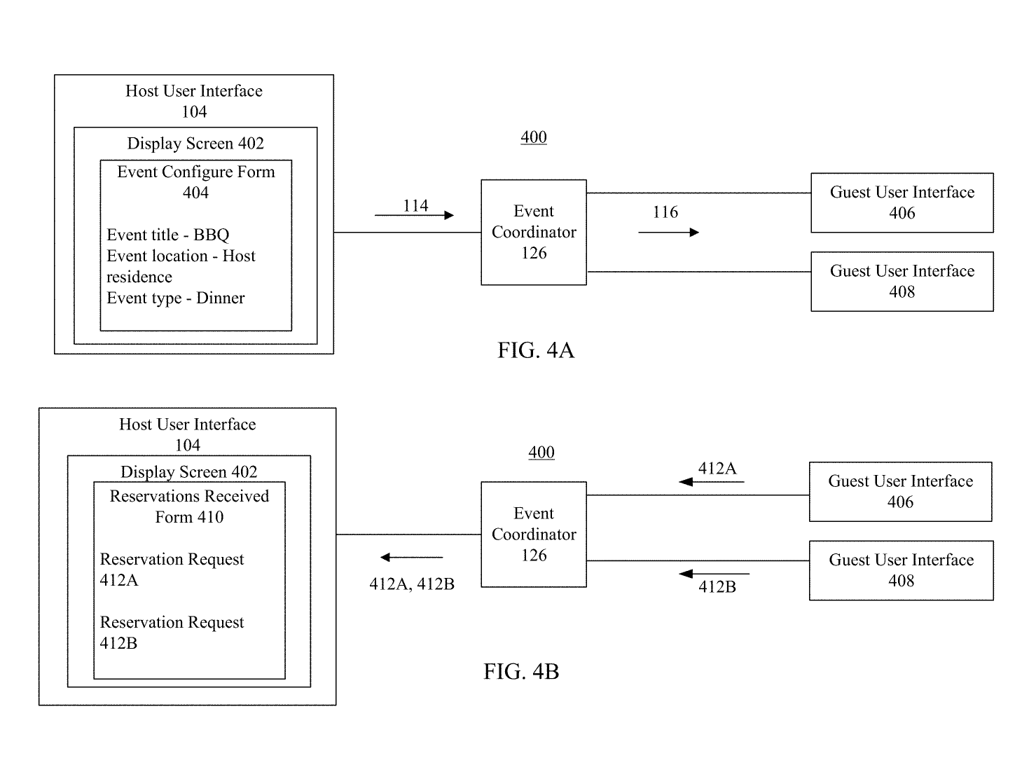

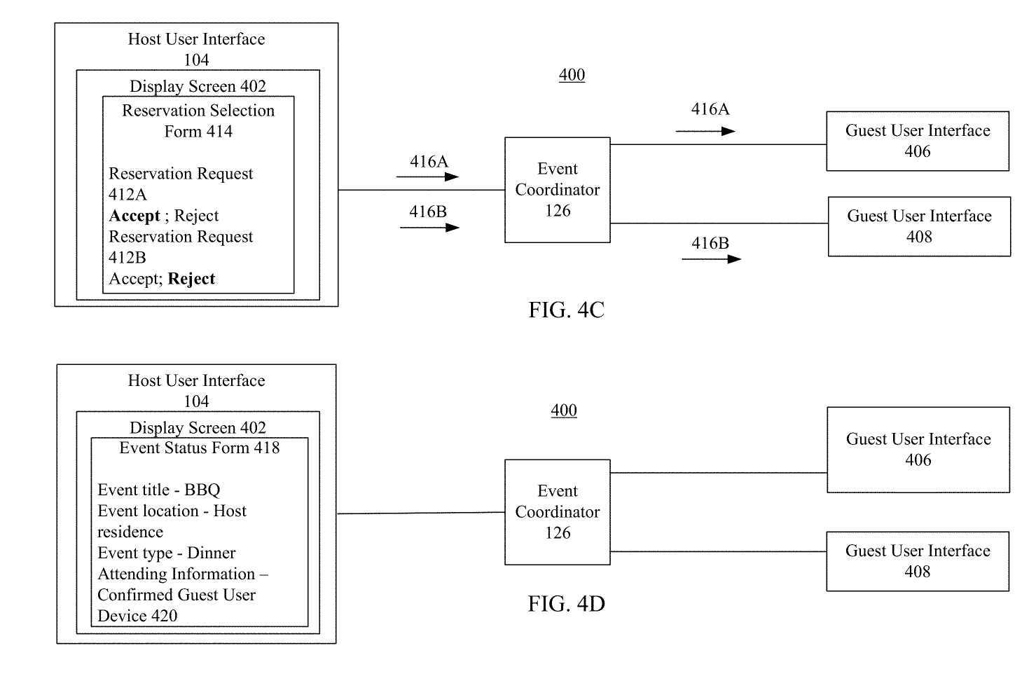

According to embodiments, events are coordinated in a communication system where a host user interacts with host user interface 104 (FIG. 1) and one or more guest users interacting with corresponding guest user interfaces 120 (FIG. 1). An example of such communications of information in a communication system 400 are illustrated with respect to FIGS. 4A-4D, as described as follows. FIGS. 4A-4D illustrate communications of information within communication system 400 regarding an event, as well as exemplary forms that may to configure the event, in embodiments.

For instance, FIG. 4A shows a block diagram of communication system 400, according to an example embodiment. Communication system 400 is an example of communication system 100 of FIG. 1 (with devices/servers not shown for ease of illustration). As shown in FIG. 4A, system 400 includes host user interface 104, event coordinator 126, a guest user interface 406, and a guest user interface 408. Guest user interface 406 and guest user interface 408 are examples of guest user interface 118 of FIG. 1, corresponding to first and second guest user devices. Event coordinator 126 interfaces host user interface 104 with guest user interfaces 406, 408. As described above, host user interface 104 enables a host user to input event details 112 for event 110. As shown in FIG. 4A, host user interface 104 includes a display screen 402, which displays an event configure form 404. A user inputs event details into event configure form 404, such as by filling in fields, selecting details from menus, etc. For instance, as shown in FIG. 4, event configure form 404 may include the following fields: Event title; Event location; and Event type. Further or alternative fields may be present. In the example of FIG. 4A, the host user input “BBQ” for the Event title, “Host residence” for the Event location, “Dinner” for the Event type. Event indication 114 is generated and transmitted (over network 130 of FIG. 1) to event coordinator 126, which in turn, transmits event information 116 to determined potential guests at guest user interfaces 406, 408, in a manner as described in further detail elsewhere herein.

Referring to FIG. 4B, in a manner as described elsewhere herein, guest user devices 406 and 408 each transmit a corresponding one of reservation requests 412A and 412B to event coordinator 126. Event coordinator 126 then transmits the received reservation requests 412A, 412B to host user interface 104, which may be displayed on display screen 402. For instance, as shown in FIG. 4B, display screen 402 displays a reservations received form 410. Reservations received form 410 displays reservation requests 412A and 412B.

Referring to FIG. 4C, display screen 402 displays a reservation selection form 414. Form 414 may include one or more UI controls that enable the host user to accept or reject each reservation request. As shown in FIG. 4C, the host user has accepted reservation request 412A and rejected reservation request 412B. As described elsewhere herein, host user interface 104 transmits acceptances and/or rejections of reservation requests through event coordinator 126 (and network 130), including an acceptance 416A transmitted to guest user interface 406 and a rejection 416B transmitted to guest user interface 408. Thus, as discussed above, the guest of guest user interface 406 is added as a booked guest for the event but the guest user of guest user interface 408 is not added as a booked guest.

Referring to FIG. 4D, and following the current example, guest user interface 406 may display a confirmation of being accepted to the event to the corresponding guest user. Furthermore, an event status form 418 displayed by display screen 402 may display a current event status to the host user as described elsewhere herein. In the example of FIG. 4D, event status form 418 displays “BBQ” for the Event title, “Host residence” for the Event location, “Dinner” for the Event type, and additionally displays Attending Information, which indicates the guest user of guest user interface 406 as a booked guest.

As previously discussed, once a guest user becomes a booked guest, that guest user may be granted privileges. For instance, the guest user may be enabled to communicate with the host user, and the host user can communicate with the booked guests, while non-booked guests may be prevented from communicating with the host user. Such communications may be desired for any reason, including to enable the guest user to find out more about the event from the host user, to enable the guest user to find out from the host user what the guest user should bring to the event (if anything), etc.

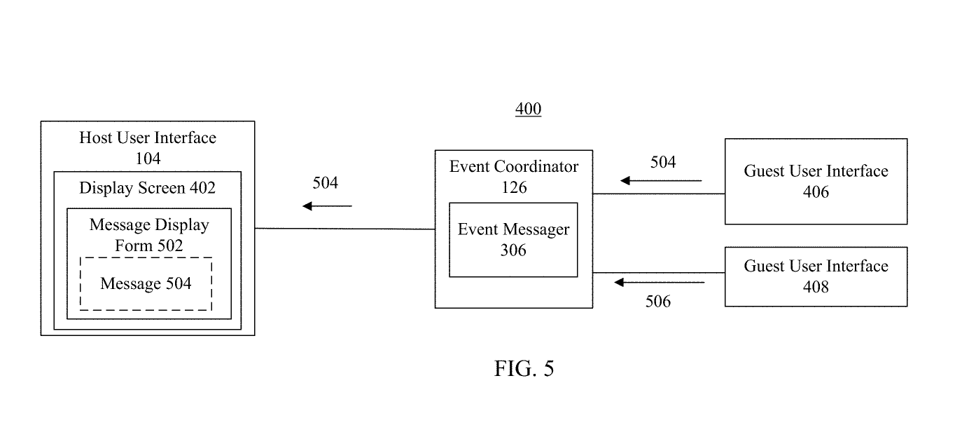

For instance, FIG. 5 shows a block diagram of communication system 400 of FIG. 4 in which event-related messaging of information is communicated, according to an example embodiment. As shown in FIG. 5, display screen 402 displays a message display form 502 generated by host user interface 104 that enables the host user to view received messages from or transmit messages to the booked guests. As shown in FIG. 5, a message 504 transmitted from guest user interface 406 is received by event messager 306 of event coordinator 126 and transmitted to the host user interface 104. Conversely, message 506 transmitted by guest user interface 408 and received by event messager 306 is not transmitted to host user interface 104 because the guest user is not a booked guest.

As previously discussed, in embodiments, event coordinator 126 may transmit a booking indication to booked guests. For instance, FIG. 6 shows a flowchart 600 for transmitting booking indication, according to an embodiment. Flowchart 600 may be implemented by event scheduler 312 of event coordinator 126. Other structural and operational embodiments will be apparent to persons skilled in the relevant art(s) based on the following discussion regarding flowchart 600.

Flowchart 600 includes step 602. In step 602, a booking indication is transmitted to each user in the list of booked guests. For example, with reference to FIG. 4D, a booking indication is transmitted to the guest user of guest user interface 406, because the corresponding guest user is now a booked guest, as well as to other booked guests.

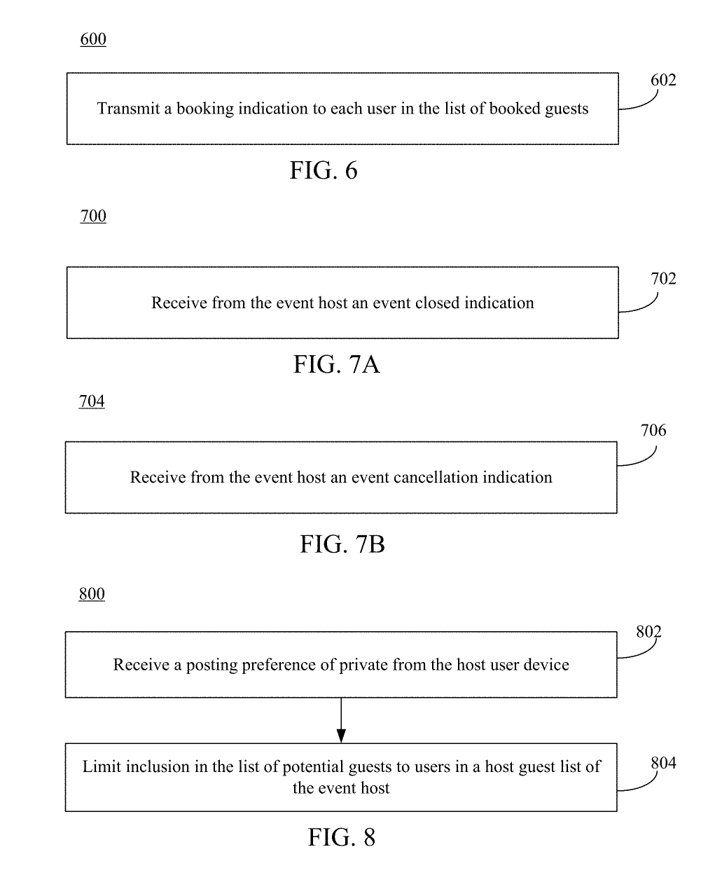

As described above, an event status may be maintained that may indicate various things, including an indication of whether the event is still open to additional guest users, closed to any further guests, canceled, etc. In an embodiment, event coordinator 126 may receive a status of an event from the host user, which may change an existing status of the event. For instance, FIG. 7A shows a flowchart for receiving an event status indication, according to an example embodiment. Flowchart 700 may be implemented by event status manager 310 (FIG. 3) of event coordinator 126. Flowchart 700 is described as follows.

Flowchart 700 includes step 702. In step 702, an event closed indication is received from the host user. For example, with reference to FIG. 1, an event closed indication may be transmitted from the host user of host user device 102 and received by event status manager 310 of event coordinator 126. The event closed indication indicates that no more guests are to be invited to the event.

FIG. 7B shows a flowchart 704 illustrating another example of receiving an event status indication, according to an example embodiment. Flowchart 704 may be implemented by event status manager 310 of event coordinator 126. Flowchart 704 is described as follows.

Flowchart 704 includes step 706. In step 706, an event cancellation indication is received from the host user. For example, with reference to FIG. 1, an event cancellation indication may be sent from the host user to event status manager 310 of event coordinator. The event canceled indication indicates that the event no longer will be held. In such case, any fees for the event paid to the event host may be refunded.

As described above, event coordinator 126 determines the list of potential guests to send event information 116. In embodiments, event coordinator 126 makes this determination independently and/or based on input from the host user. For instance, FIG. 8 shows a flowchart 800 for determining a list of potential guests, according to an example embodiment. Flowchart 800 may be implemented by potential guest determiner 304 of event coordinator 126. Flowchart 800 is described as follows.

Flowchart 800 begins with step 802. In step 802, a posting preference of private is received from the host user. For example, with reference to FIG. 3A, a posting preference of “private” be selected by the host user by interacting with host user interface 104, and may be transmitted to potential guest determiner 304 by the host user (as described in further detail below, the host user may alternatively select a posting preference of “public”). The posting preference of private indicates that the host user does not want all possible guest users to be able to request to attend the event, but instead desires a limited subset of all possible guest users to be able to request attendance, such as a set of guest users that the host user indicates in a host guest list.

In step 804, the inclusion in the list of potential guests is limited to users in a host guest list of the event host. For instance, with reference to FIG. 3A, the list of potential guests is limited by potential guest determiner 304 to users in the host guest list of the event host. Only the users in the host guest list are provided are notified of the event and enabled to provide a reservation request, as described elsewhere herein.

For instance, as described above, the host user may have a host guest list. This host guest list may be generated to include guest users that request to join the host user's host guest list and are confirmed by the host user, and/or may include guest users asked by the host user to join the host guest list and confirmed by those guest users. When a guest user is listed in the host user host guest list, and the host user has a private posting private, only the guest users on the host user's host guest list receive event information 116.

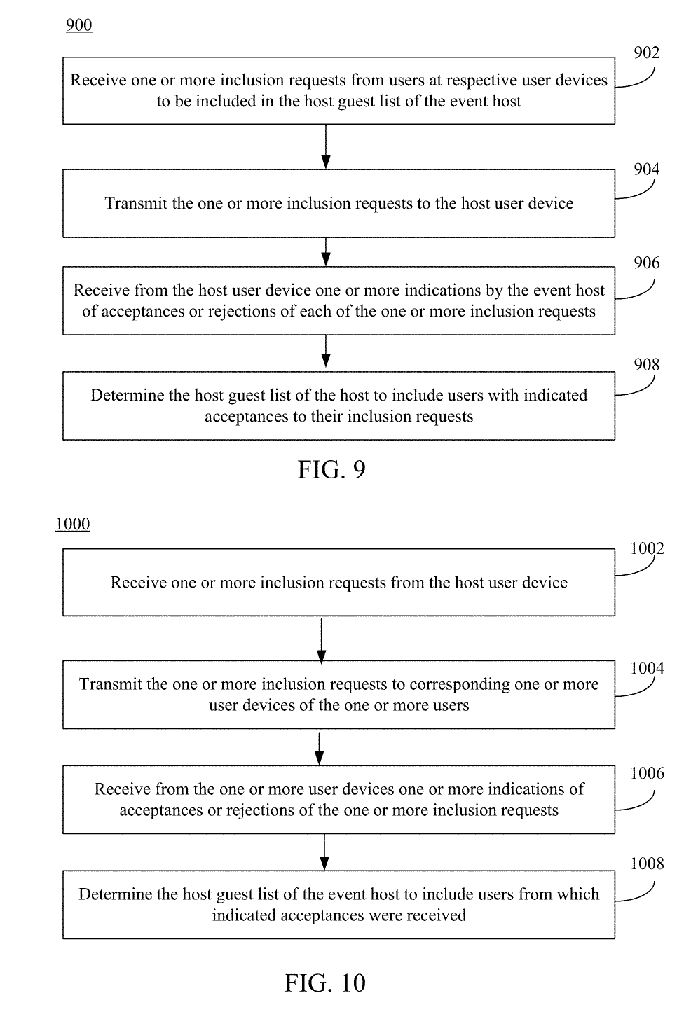

FIG. 9 shows a flowchart 900 for adding users to a host guest list, according to an example embodiment. Flowchart 900 may be implemented by host guest list determiner 314 of event coordinator 126. Flowchart 900 is described as follows.

Flowchart 900 begins with step 902. In step 902, one or more inclusion requests are received from users at respective user devices to be included in the host guest list of the event host. For example, and with reference to FIGS. 1 and 3A, a guest user of guest user device 118 may submit an inclusion request, such as by interacting with a user interface generated by host guest list selector/requestor 336, if the guest user desires to be added to the host user's host guest list. The request is transmitted by guest user device 118, and received by host guest list determiner 314 at event coordinator 126.

In step 904, the one or more inclusion requests are transmitted to the host user device. For example, host guest list determiner 314 transmits the inclusion request(s) from guest user device 118 to host user device 102.

In step 906, one or more indications by the event host of acceptances or rejections of each of the one or more inclusion requests are received from the host user device. For example, the host user of host user device 102 accepts or rejects the received inclusion request(s) such as by interacting with a user interface generated by host guest list selector/requestor 326. The acceptances and rejections are transmitted to event coordinator 126.

In step 908, the host guest list of the host is determined to include users with indicated acceptances to their inclusion requests. For instance, if the host user accepted the inclusion request received from the guest user of guest user device 118, the guest user is included in the host guest list of the host. Conversely, if the host user rejected the inclusion request, then the guest user of guest user device 118 is not included in the host guest list of the host.

According to an alternative embodiment, FIG. 10 shows a flowchart 1000 for adding users to a host's host guest list, according to an example embodiment. Flowchart 1000 may be implemented by host guest list determiner 314 of event coordinator 124. Flowchart 1000 is described as follows.

Flowchart 1000 begins with step 1002. In step 1002, one or more inclusion requests are received from the host user device. For example, with reference to FIGS. 1 and 3A, if the host user of host user device 102 desires to include a particular user in their host guest list, the host user may submit an inclusion request, such as by interacting with a user interface generated by host guest list selector/requestor 326. The request is transmitted to host guest list determiner 314 at event coordinator 126.

In step 1004, the one or more inclusion requests are transmitted to the corresponding one or more user devices of the one or more users. Accordingly, host guest list determiner 314 forwards the received request to guest user device 118.

In step 1006, one or more indications of acceptances or rejections of the one or more inclusion requests is received from the one or more user devices. For example, the guest user of guest user device 118 accepts or rejects the inclusion request, such as by interacting with a user interface generated by host guest list selector/requestor 336, and the acceptance or rejection is transmitted to event coordinator 126.

In step 1008, the host guest list of the event host is determined to include users from which indicated acceptances were received. For example, if the guest user of guest user device 118 accepted the inclusion request, host guest list determiner 314 includes the guest user on the host guest list of the host. Conversely, if the guest user of guest user device 118 rejected the inclusion request, the guest user is excluded from the host guest list of the host.

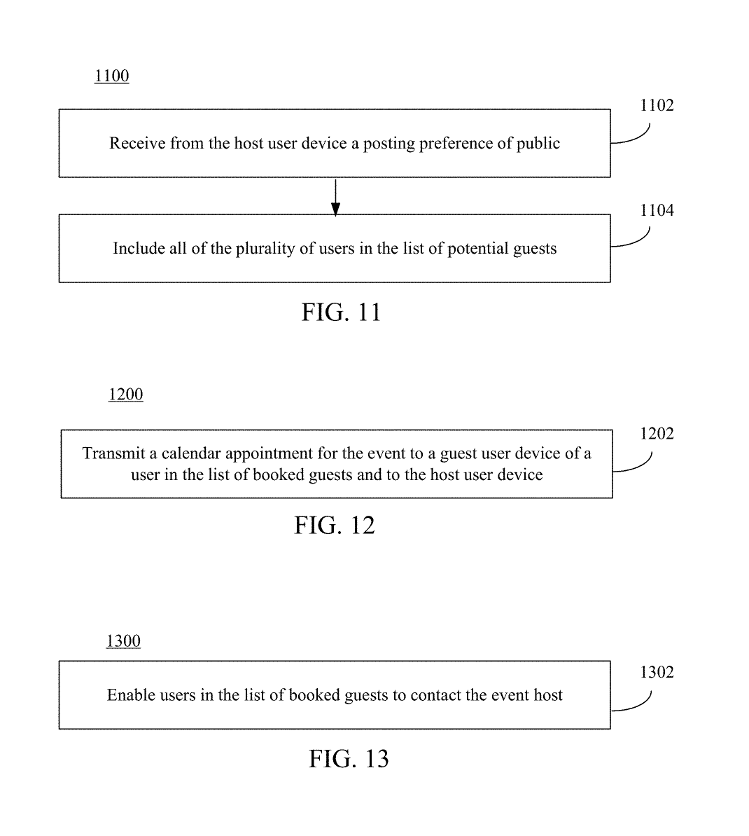

As described above, event coordinator 126 is configured to determine which users to include in the list of potential users based at least on input from the host user. For instance, a public posting preference of the host user may be used to widen the scope of guest users enabled to attend the event. FIG. 11 shows a flowchart 1100 for determining a list of potential guests using a public posting preference, according to an example embodiment. Flowchart 1100 may be implemented by potential guest determiner 304 of event coordinator 126. Flowchart 1100 is described as follows.

Flowchart 1100 begins with step 1102. In step 1102, a posting preference of public is received from the host user. For example, with reference to FIG. 3, a posting preference of public may be submitted by the host user (e.g., using a user interface provided by host guest list selector/requestor 326). The public posting preference is transmitted to potential guest determiner 304 by the host user device.

It is noted that when an event is posted with a public posting preference, all available users may be enabled to submit a reservation request to the event. For instance, guest users may be enabled to search (via a user interface provided by reservation requestor 334) for all events available anywhere (no event filtering), or for particular types of events, events within a predetermined distance of the guest user (or having geographical/location attribute), and/or according to further event filtering constraints. For example, in an embodiment, reservation requestor 334 of event booking application 106 in guest user device 118 may include or may access a location determiner in guest user device 118 that is configured to determine a current location of guest user device 118. The location determiner may determine the current location of guest user device 118 in any manner, including using GPS (global positioning system) techniques, local positioning systems (e.g., using cellular base stations, Wi-Fi access points, radio towers, etc.), and/or using other positioning techniques, as would be known to persons skilled in the relevant art(s). For instance, in a GPS embodiment, the location determiner may include a GPS module that includes one or more receivers that receive GPS signals from satellites for the purpose of determining a current location on Earth of guest user device 118. The GPS module may calculate its location by timing the signals transmitted by the GPS satellites. The GPS module may determine the transit time of each signal and may calculate the distance to each satellite. These distances, along with the locations of the satellites, may be used in a positioning algorithm (e.g., trilateration, etc.) to determine the location of the GPS module. The GPS module may generate the location in the form of latitude and longitude, and in some embodiments may also determine altitude. In other embodiments, the GPS module may determine and/or indicate location in other ways, as would be known to persons skilled in the relevant art(s). In an embodiment where the guest user is enabled to search for events within a predetermined distance of the user, reservation requestor 334 may be configured to compare the determined current location of guest user device 118 to the event locations of any number of available events, and to cause the events having event locations within the predetermined distance of the determined current location to be displayed to the guest user for selection (filtering out other events). In embodiments, when an event is posted with a public posting preference, users on the host guest list may still be notified of the event posting. In embodiments, guest users may be enabled to search (via a user interface provided by reservation requestor 334) for a specific host user and see some or all of the host user's posted events.

In step 1104, all of the plurality of users are included in the list of potential guests. For instance, with reference to FIG. 3, the list of potential guests determined by potential guest determiner 304 includes all of the plurality of users, which may be all users that have accounts with event booking application 106, or all such users as constrained by one more event filters used by guest users searching for events.

In an embodiment, a calendar appointment is transmitted to attendees of an event, to automatically enter the event in their schedules. For instance, FIG. 12 shows a flowchart 1200 for transmitting a calendar appointment for an event, according to an embodiment. Flowchart 1200 may be implemented by event scheduler 312 of event coordinator 126. Flowchart 1200 is described as follows.

Flowchart 1200 includes step 1202. In step 1202, a calendar appointment is transmitted to a guest user device of a user in the list of booked guests and to the host user device. For example, with reference to FIG. 4D, event scheduler 312 analyzes event details 112 to determine a time/date planned for the event, and optionally the event location, and generates a corresponding calendar appointment. The calendar appointment is transmitted to all of the booked guest users. The calendar appointment is also transmitted to the host user at host user device 102. Event booking application 106 or a calendar application at each device inputs the calendar appointment into the respective calendar.

In embodiments, once a guest user is confirmed as a booked guest, the guest user and the host user may contact one another via messages. For instance, FIG. 13 shows a flowchart 1300 for enabling users in the list of booked guests to contact the event host, according to an example embodiment. Flowchart 1300 may be implemented by event messager 306 of event coordinator 126. Flowchart 1300 is described as follows.

Flowchart 1300 includes step 1302. In step 1302, the users in the list of booked guests are enabled to contact the event host. For example, with reference to FIG. 5, guest user interface 406 may enable the guest user to generate message 504, and to transmit message 504 to the host user of host user interface 104.

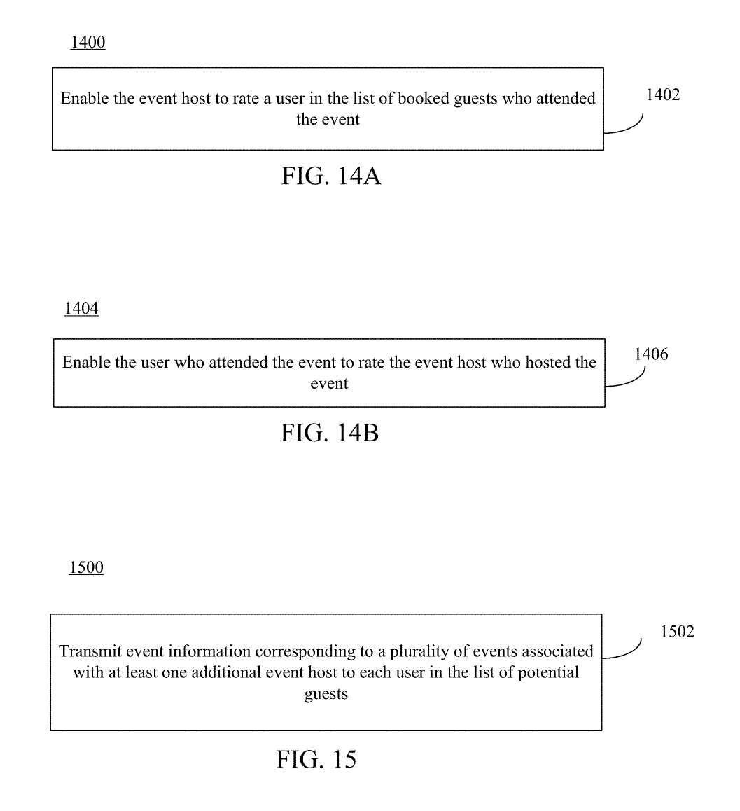

In embodiments, after the event, the event host and the booked guests who attended the event may be enabled to rate each other. For instance, FIG. 14A shows a flowchart 1400 for enabling the event host to rate a user in the list of booked guests who attended the event, according to an example embodiment. Flowchart 1400 may be implemented by event rating manager 316 of event coordinator 126. Flowchart 1400 is described as follows.

Flowchart 1400 includes step 1402. In step 1402, the event host is enabled to rate a user in the list of booked guests who attended the event. For example, with reference to FIG. 4D, after the event, the host user of host user interface 104 may rate the corresponding confirmed guest of guest user interface 406, as described elsewhere herein.

Furthermore, FIG. 14B shows a flowchart 1404 for enabling the user who attended the event to rate the event host who hosted the event, according to an example embodiment. Flowchart 1404 may be implemented by event rating manager 316 of event coordinator 126. Flowchart 1404 is described as follows.

Flowchart 1404 includes step 1406. In step 1406, the user is enabled to rate the event host who hosted the event. For example, with reference to FIG. 4D, after the event, the guest user of guest user interface 406 may rate the host user of host user interface 104, as described elsewhere herein.

In embodiments, guest users may receive event information for multiple different events from multiple host users. For example, FIG. 15 shows a flowchart 1500 for transmitting event information from multiple hosts to each user in the list of potential guests, according to an example embodiment. Flowchart 1500 may be implemented by event coordinator 126. Flowchart 1500 is described as follows.

Flowchart 1500 includes step 1502. In step 1502, event information corresponding to a plurality of events associated with at least one additional event host is transmitted to each user in the list of potential guests. For example, and with reference to FIG. 1, when multiple host users exist, event coordinator 126 determines the list of potential guests for each event and transmits the event information to each user of the list of potential guests. As such, each guest user has the opportunity to request to attend multiple events, to select an event from multiple conflicting events, to select events to request to attend based on the guest user's own likes, dislikes, hobbies, best friends, etc.

Accordingly, embodiments in a communication system enable events to be set up and booked in manner that enables more surety for the host user. For instance, by receiving and accepting/rejecting reservation requests to book guests, the host user is imparted the knowledge of who is going to attend the event, enabling the host user to more efficiently plan and staff the event.

Note that in some embodiments, functionality described herein as being performed by event coordinator 126 may alternatively be performed by event booking application 106, and functionality described herein as being performed by event booking application 106 may alternatively be performed by event coordinator 126.

### III. Further Embodiments and Additional Details

The present section describes additional embodiments and further details to embodiments described elsewhere herein. The embodiments described in this subsection may be combined with each other in any manner, and can be combined with embodiments described elsewhere herein in any manner.

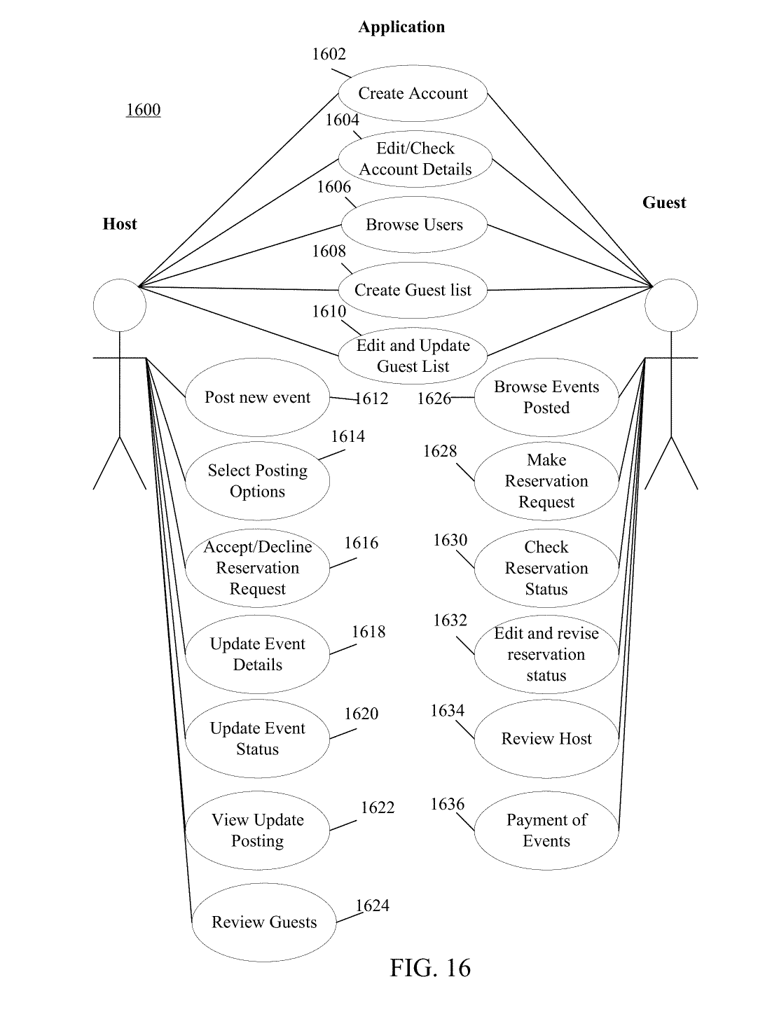

The present patent application describes a mobile app which is a combination of a social platform and reservation system. It is a method of allowing a selection of guests, based upon personal profiles, reviews of hosts, and guests creating a list “guest list” for the purpose of generating a reservation system. The reservation system is based on postings and notification of events and meals by hosts; the events are to be viewed by the users of the application and by people selected on a personal guest list. The reservation system allows a booking request to be made by a user of the application to be accepted by a host of an event or meal. This is depicted in flowchart 1600 of FIG. 16.

Herein follows a more detailed explanation. The mobile app first has users create a profile 1602. This is a profile creation method where the user enters information pertaining to school, interests, affiliations, memberships, etc.

Users can be either a guest user or a host user. Hosts can create an event by posting 1612. Based on the review of the profile, users can request to be on a host's guest list.

If a host has guest requests, then everyone on the guest list will receive notification of a posted event. The event may be brunch, happy hour, dessert, etc.

The app will run through a list of questions regarding the event, then create the event.

Users on the host's guest list will receive notification of the posting of the event.

Once it's posted, everyone on the guest list can see it. Users can request to come.

The host user can have the opportunity to accept the reservation 1616. If the host user has already accepted the max number of people they would like to host, he/she can simply reject further requests.

Events can either be free to have a charge for attendance. Once accepted, payment will be charged 1636. In an embodiment, there are no tips; it is just a transaction. The host will get paid after the event.

The reservation system also allows users to review other user's profiles in regards to their interactions and experiences with them 1624, 1634.

It is important to note the present patent application has an interlinkage of social media; there is interaction between social media and reservation processes. Reservation is based upon the interaction on the social media, through actions such as reviewing other people's profiles, and requesting to be on the guest list.

The present patent application combines social media and reservation. The reservation system allows users to attend a private function at someone's home. Notably, the reservation system is not limited to restaurants or cafes. The present patent application can also allow users to make reservations at a home cook's residence.

Guest users can download the app to see events and meals posted by a user's friends and other hosts. Host users can also host and post a meal or event. Users can be either a Host User and a Guest User.

Whether the activity involves cooking or offering a drink, utilizing the host user process is an easy way for the user to convert his/her home into a restaurant with control of who would be coming.

In the present patent application, a combination social media and reservation platform comprises of: a guest user process, a host user process, a guest list creation process, a marketplace process with trust subsystem, a set of user account processes, a set of user interface processes for the host user, a set of interface processes for the guest user, a set of rating and review processes, and a biometric authentication dongle.

The first major component/process of the present patent application is the guest user process. The user can browse meals posted by his/her friends, neighbors, and make a reservation request.

Notably, the present patent application is not limited to restaurants as venues or meals as events. The process supports a plurality of venues and event types, such as a table for four people at a backyard BBQ, roof top happy hour, tea on a private porch, etc. Guests are not required to socialize with the host. However, the present patent application supports that option, especially if the user knows the host as a friend.

Once the user's reservation is accepted, the user need only show up at the event to eat and that is the only requirement. If the user's meal has a cost, the user will be billed when his/her reservation is accepted. Once the user sets up an account with credit card information, the user will never need to pull out cash or credit card for payment. Payment data is stored within the present patent application's system.

In an embodiment, tips are not required. Payment is thus handed in the aforementioned manner to reduce inconvenience for the user.

The next major component/process of the present patent application is the host user process. The process allows the user to effectively turn his/her home into a bistro, coffee shop or wine bar at any time. The process allows the user to post any type of event, whether it be a meal, breakfast, lunch, happy hour, dinner, dessert, drinks, etc.

The user can select the time he/she wants to host, choose the cost per person or make it free, and devise a menu. The user can post the meal to the public for all users to see, or make it private, meaning only friends are allowed to see and book the event. The process is designed to be a user-friendly means to see who is free and wants to come.

When the user receives a booking request, he/she will decide whether to accept the request. Profiles will be shown so the user knows who is making a request to come. The user will control who to accept and how many guests will attend, whether its two guests or twenty guests. The user can update his/her event as “Fully booked” when the user has accepted all the guests he/she desires 1620.

Notably, the user can charge for the provided meal, with a set price per person or type of person, i.e., child vs. adult, senior citizen, etc. This is an option for the user regardless of the purpose of the event, whether he/she wants to earn some money, cover costs, or fundraise.

The next major component/process of the present patent application is the guest list creation process 1608. In an embodiment, all users can see each other's profiles 1606 and request to be on each other's Guest List. When a host posts an event, everyone on the hosts' Guest List will receive a notice of the event. This is designed to be a user-friendly method to get notice of events and meals hosted by a user's friends. The Guest List may be updated and edited 1610.

The next major component/process of the present patent application is the marketplace process 1624, 1634 with trust subsystem. Both host and guest users can view each other's profile. The profiles will show social connections through neighborhoods, apartment buildings, schools, sports, churches, or professions.

Hosts and Guests will be rated by reviews of one another. There is no charge for setting up an account or posting a meal with the present patent application. Guests are only charged if the meal has a cost and when the reservation is accepted. The location of the event or meal is disclosed after reservation is accepted by the host. All fees and costs will be shown before the booking. The present patent application's trust subsystem will hold all payment to the host in escrow until after guests are served.

The next major component/process of the present patent application is the set of user account processes. This set is comprised of the account creation sub-process, the password recovery sub-process, the profile entry sub-process, the profile editing sub process, and the account options sub-process.

The first sub-process is the account creation sub-process 1602. In an embodiment, the user needs to enter several fields. In an embodiment, the user needs to enter his/her email, mobile number, create a password, verify his/her phone number, as well as perform ID verification by text.

The next sub-process is the password recovery sub-process. This is an industry standard methodology for allowing users to retrieve their passwords or reset their password. Methodologies may include but are not limited to “secret question” type responses and well as send-link-to-user-email methods.

The next sub-process is the profile entry sub-process. In an embodiment, the user must enter his/her first name and last name. The user must also enter the neighborhood he/she lives in, and zip code. The user also enters his/her schools, i.e., high school, college, post graduate schools attended, etc. The user enters his/her children's schools, i.e., elementary, middle and high school connections with other families, etc.

The user also enters details regarding his/her occupation/profession/trade. The user enters information on his/her other affiliations, i.e., church, sports team, etc. The user also needs to list his/her email and phone number previously entered.

The user also has the ability to add a picture of a person on the profile page. Adding this picture may be either mandatory or optional, depending on the embodiment.

Notably, alternative or future embodiments may include other fields not explicitly included here.

The next sub-process is the profile editing sub-process 1604. The user will be able to edit the fields from the aforementioned profile entry sub-process.

The next sub-process is the account options sub-process. In an embodiment, the options are as follows: change password, payment history, i.e., includes viewing of fields such as but not limited to Event Date, meal, Amount, Paid out, etc. The user also has the ability to View Terms and Conditions, View Private Policy, and set notifications.

The notifications have their own set of sub-options. The user can set the notification method; in the preferred embodiment, this is either text or email. The default is to send by email.

In the options, there may also be a Promotion Points Feature in alternative or future embodiments.

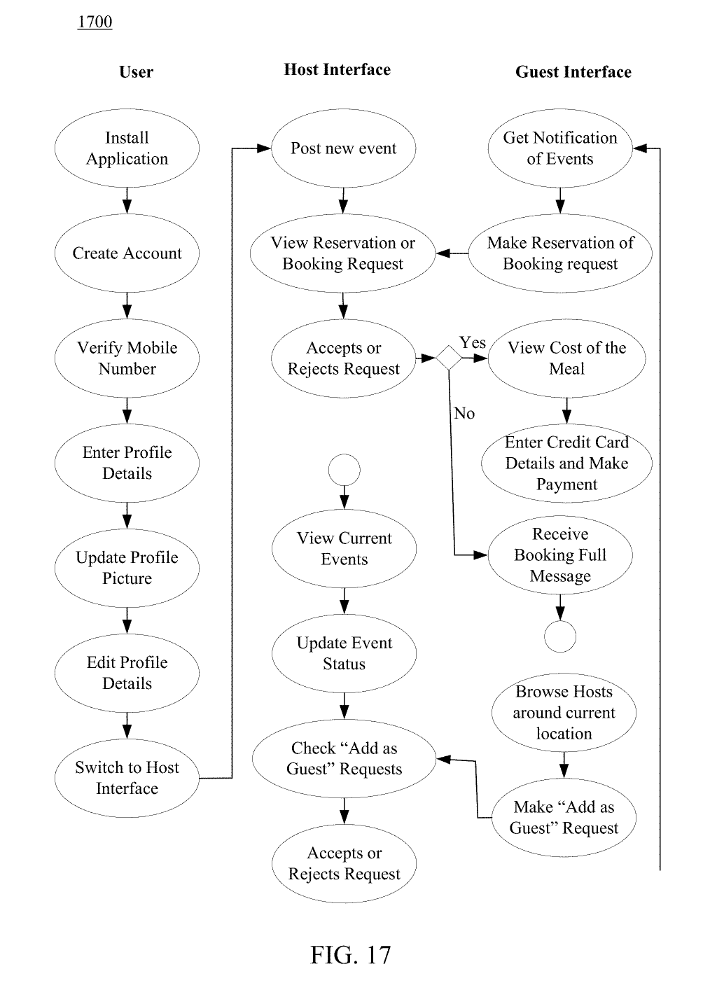

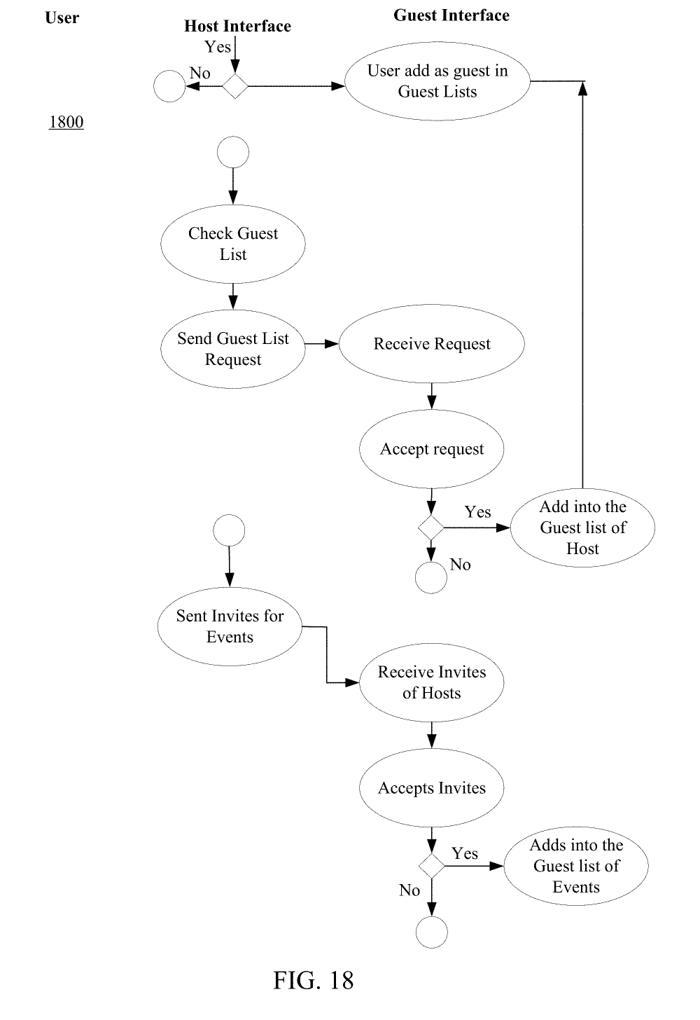

The next major component/process of the present patent application is the set of user interface processes for the host user. This set is itself comprised of multiple subprocesses: a post new event sub-process 1612, a sub-process for viewing new booking request, a current event sub-process, and a guest list sub-process. This is depicted in flowchart 1700 of FIG. 17 and flowchart 1800 of FIG. 18, with continued reference to flowchart 1600 of FIG. 16.

In an embodiment, the user can first choose which meal/event to list. Options include but are not limited to: Dinner, Brunch, Happy Hour, Lunch, Dessert, Breakfast, Wine Tasting, Tea Party, Fundraiser, a Drink, Party, Other.

Next, the user selects the dining location. Options include but are not limited to: House, Town house, Apartment building, Other, etc.

Next, the user needs to provide Address of Location. In an embodiment, only confirmed guests see the address.

Next, the user selects the event date. The user chooses the date and time range.

Next, the user sets a price per person. It can be free, or in the preferred embodiment, the amount can be $1-$500. The host can enter the price.

Next, the user can give the event or meal a title. In an embodiment, the title runs a maximum of ten words.

Next, the user can enter the menu. In an embodiment, this menu runs a maximum of thirty words. The menu will list all food offered, drinks offered, etc.

Next, the user can enter optional additional information.

The user can specify whether the event is BYOB Allowed, BYOB Not Allowed.

The user can specify the cancellation policy. If it is Flexible, the event can be cancelled anytime. If it is Strict, the event must be cancelled before 24 hours of the [meal] on [event date].

The user can select where the dining table is offered. Options include but are not limited to: Dining room, Living room, Kitchen, Table, Back Yard, Porch, Deck, Screened Porch, Roof Top, Balcony, Other, etc.

The user can select the Type of Cuisine. Options include but are not limited to: American, Italian, Asian, Mexican, French, Indian, Middle Eastern, Fusion, International, European, Other, etc.

The user can also attach a photo of food or select pre-loaded pictures that best depict the meal.

The user can preview the listing. The user will have the option to edit the listing if so desired.

The user can select a posting preference 1614, and make a post either private or public.

Public means all users of the present patent application can see the event. All guests will receive the message.

Private means only selected people can see the event. Only selected guests chosen by the host will receive the message. In an embodiment, the app will display a Guest list and allow Host to select all or individual guest by check box.

The user can also send out notifications. The user can send out a notification to all guests. In an embodiment, the notification States “[Host Name] has posted [Meal] on [Invention's Brand Name].” Notably, there is an option to create an account for first time users here.

The next sub-process is for viewing new booking requests 1616. The user can either accept or reject booking. In an embodiment, the interface may state, “[guest name] has requested to book your [meal] on [event date].” The user can either Accept or send a message stating to the effect, “Sorry we are booked.”

The next sub-process is the current event sub-process 1622. This is the current event on the host page. Fields and options may include but are not limited to: Title of Event, Invite Guest/Cancel Event/Close the Event as Full, Reservations, Guests Name, possibly including # of people, Reservation Status, pending, accepted, full, Contact Guest, etc. A host user may also update the event details 1618.

The next sub-process is the guest list sub-process. Fields and options may include but are not limited to: View Current Guest List, and View Guest Request. When Users request to be on host's guest list, the user can list all request here. The interface may state, “[User name] has requested to be on your Guest list. The user may have the option to [Add] or choose the [Not Now] option.

The user can also control access to the contact list, Import Friends from Contact

List to Guest List, and Add Guest. In the case of the latter, the recipient will receive a statement to the effect of, “[Host name] has invited you to be on their guest list to view parties and events posted by [host name] . . . to accept please sign in.”

The next major component/process of the present patent application is the set of interface processes for the guest user. This set is comprised of: a date-based meal listing process, a distance-based host listing process, a set of user reservations processes on a guest page, and a distance-based venue listing process. This is depicted in FIG. 17 and FIG. 18 with continued reference to FIG. 16.

The first process is the date-based meal listing process. This process lists/sorts meals with most recent up to the current date, to the farthest from the current date. The fields and options may include but are not limited to: View List of Meals, View Meal Details-[Meal] [Title] [Price Per Person] [rating reviews *****], Show Host Information, and a Book Now. The Book Now features are the same as those in the Book Now feature under Meals Around You 1626, discussed below.

The next process is the distance-based host listing process. This lists/sorts the hosts closest to the user's current location, to the farthest showing distance. The user has the ability to Send Request to Host and Receive a Notification of their all Hosted Events. The user also has the ability to Send Request to be on Guest List.

The next process is the set of user reservations processes on a guest page. This process lists/sorts meals with most recent to current date, to the farthest from current date. The user can View List of Meals, the Date of Event, the Title of Event, the number of people attending, and the Reservation Status. The reservation status can be pending, accepted, fully booked, etc. In an embodiment, there is also Messaging. Messaging provides the user with the ability to Contact Guest, which is a secure messaging ability which does not disclose the user's phone number nor email.

The next process is the distance-based venue listing process. This lists/sorts the venues, starting with those closest to current location, to those with the farthest showing distance. Fields and options may include but are not limited to: View List of Meals, View Meals Details-[Meal] [Title] [Price Per Person] [rating reviews *****], All Information, List Closest First Within 5 miles and the Rest of Listing by Distance, Show Host Information, and a Book Now option.

The Book Now option is itself comprised of a plurality of sub-options. These may include but are not limited to: Enter Number of People, Enter Adult and Children i.e., those 12 and under, Select Time, Accept Terms of Use, Request Booking 1628.

There is also an If Host Accepts option. Under this option, there are a number of sub-options. In an embodiment, the fields and options may include but are not limited to:

Show Cost, Enter Credit Card Details, Save Card Details for Future Booking, and View Booking Confirmation Message.

In an embodiment, the View Booking Confirmation Message may read to the effect of: “Your requested reservation has been accepted. You have been billed $______ for [meal] hosted by [host name]. The event location is at [address]. The contact information for your host is ______ or you can send the host a message on the message board. Contact your host for any further information or directions if needed. Enjoy.”

Other options may include: Contact Host for Further Information, Check Directions to Host, Cancel Booking 1632, and View Cancellation Policy.

A guest user may check the reservation status 1630. A guest user may edit and revise the reservation status 1632. Notably, in an embodiment, all events/meals are deleted after the set event date.

The next major component/process of the present patent application is the set of rating and review processes 1624, 1634. Fields and options may include but are not limited to: Host will Review the Guest After Event, Guest will also Review the Host After Event. Ratings may include: Excellent, Good, Fair, Poor.

Notably, alternative or future embodiments may utilize a different ranking system or include complimentary methods. In addition to an industry-standard 4-5-star ranking system, the user can rate other users with icons. For example, a red-hot pepper icon near a user's review may indicate the users' events are hot or well-reviewed, or has seen significant recent activity.

Additionally, there is an option to allow the Host to Rate the Guest. The interface may read, “Please rate your guest [Guest name] attending [meal] on [event date].”

There is also an option for the Guest to Rate the Host. The interface may read:

“Please rate your [meal] hosted by [host name] on [event date].”

There may also be an option to Ask if Host and guest wants to be added to Host's guest list.

There may be an additional field; this is for optional written comments. In an embodiment, the maximum word count is 25 words.

The next major component/process of the present patent application is the biometric authentication dongle. This may be an optional feature which is not present in all embodiments. The dongle is a retrofit device designed to attach to a smart mobile device. It may use fingerprint identification as a means of biometric authentication. Alternative or future embodiments may utilize other means of biometric authentication.

Although the invention has been explained in relation to its preferred embodiment, it is to be understood that many other possible modifications and variations can be made without departing from the spirit and scope of the invention. Obvious changes, modifications, and substitutions may be made by those skilled in the art to achieve the same purpose as the invention. The exemplary embodiments are merely examples and are not intended to limit the scope of the invention. It is intended that the present patent application cover all other embodiments that are within the scope of the descriptions and their equivalents.

### IV. Example Computer System Implementations

Host user device 102, guest user device 118, server 124, event booking application 106, event coordinator 126, any of the components of event booking application 106 and event coordinator 126 shown in FIG. 3, flowchart 200, flowchart 600, flowchart 700, flowchart 704, flowchart 800, flowchart 900, flowchart 1000, flowchart 1100, flowchart 1200, flowchart 1300, flowchart 1400, flowchart 1404, and/or flowchart 1500 may be implemented in hardware, or hardware combined with software and/or firmware, including being implemented as computer program code/instructions configured to be executed in one or more processors and stored in a computer readable storage medium, as hardware logic/electrical circuitry, being implemented together in a SoC, such as an SoC that includes an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

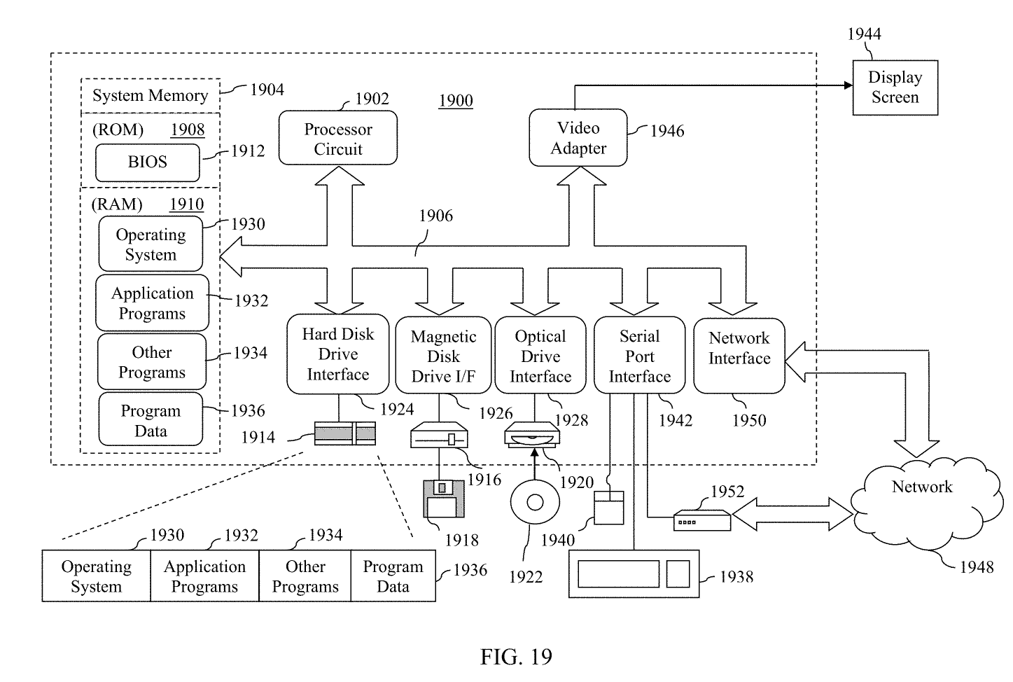

Furthermore, FIG. 19 depicts an exemplary implementation of a computing device 1600 in which embodiments may be implemented. For example, host user device 102, guest user device 118, and/or server 124 may be implemented in one or more computing devices similar to computing device 1900 in mobile or stationary embodiments, including one or more features of computing device 1900 and/or alternative features. The description of computing device 1900 provided herein is provided for purposes of illustration, and is not intended to be limiting. Embodiments may be implemented in further types of computer systems, as would be known to persons skilled in the relevant art(s).

As shown in FIG. 19, computing device 1900 includes one or more processors, referred to as processor circuit 1902, a system memory 1904, and a bus 1906 that couples various system components including system memory 1904 to processor circuit 1902. Processor circuit 1902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1902 may execute program code stored in a computer readable medium, such as program code of operating system 1930, application programs 1932, other programs 1934, etc. Bus 1906 represents one or more of any of several types of bus structures, including a memory bus or memory controller, a peripheral bus, an accelerated graphics port, and a processor or local bus using any of a variety of bus architectures. System memory 1904 includes read only memory (ROM) 1908 and random access memory (RAM) 1910. A basic input/output system 1912 (BIOS) is stored in ROM 1908.

Computing device 1900 also has one or more of the following drives: a hard disk drive 1914 for reading from and writing to a hard disk, a magnetic disk drive 1916 for reading from or writing to a removable magnetic disk 1918, and an optical disk drive 1920 for reading from or writing to a removable optical disk 1922 such as a CD ROM, DVD ROM, or other optical media. Hard disk drive 1914, magnetic disk drive 1916, and optical disk drive 1920 are connected to bus 1906 by a hard disk drive interface 1924, a magnetic disk drive interface 1926, and an optical drive interface 1928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1930, one or more application programs 1932, other programs 1934, and program data 1936. Application programs 1932 or other programs 1934 may include, for example, computer program logic (e.g., computer program code or instructions) for implementing host user device 102, guest user device 118, server 124, event booking application 106, event coordinator 126, any of the components of event booking application 106 and event coordinator 126 shown in FIG. 3, flowchart 200, flowchart 600, flowchart 700, flowchart 704, flowchart 800, flowchart 900, flowchart 1000, flowchart 1100, flowchart 1200, flowchart 1300, flowchart 1400, flowchart 1404, and/or flowchart 1500 (including any suitable step of flowcharts 200, 800, 900, 1000, 1100), and/or further embodiments described herein.

A user may enter commands and information into the computing device 1900 through input devices such as keyboard 1938 and pointing device 1940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1902 through a serial port interface 1942 that is coupled to bus 1906, but may be connected by other interfaces, such as a parallel port, game port, or a universal serial bus (USB).

A display screen 1944 is also connected to bus 1906 via an interface, such as a video adapter 1946. Display screen 1944 may be external to, or incorporated in computing device 1900. Display screen 1944 may display information, as well as being a user interface for receiving user commands and/or other information (e.g., by touch, finger gestures, virtual keyboard, etc.). In addition to display screen 1944, computing device 1900 may include other peripheral output devices (not shown) such as speakers and printers.

Computing device 1900 is connected to a network 1948 (e.g., the Internet) through an adaptor or network interface 1950, a modem 1952, or other means for establishing communications over the network. Modem 1952, which may be internal or external, may be connected to bus 1906 via serial port interface 1942, as shown in FIG. 19, or may be connected to bus 1906 using another interface type, including a parallel interface.

As used herein, the terms “computer program medium,” “computer-readable medium,” and “computer-readable storage medium” are used to refer to physical hardware media such as the hard disk associated with hard disk drive 1914, removable magnetic disk 1918, removable optical disk 1922, other physical hardware media such as RAMs, ROMs, flash memory cards, digital video disks, zip disks, MEMs, nanotechnology-based storage devices, and further types of physical/tangible hardware storage media (including memory 1020 of FIG. 10). Such computer-readable storage media are distinguished from and non-overlapping with communication media (do not include communication media). Communication media embodies computer-readable instructions, data structures, program modules or other data modulated in a data signal such as a carrier wave. The term “modulated data signal” means a signal that has one or more of its characteristics set or changed in such a manner as to encode information in the signal. Communication media embodies wireless media including acoustic, RF, infrared and other wireless media, as well as wired media. Embodiments are also directed to such communication media that are separate and non-overlapping with embodiments directed to computer-readable storage media.

As noted above, computer programs and modules (including application programs 1932 and other programs 1934) may be stored on the hard disk, magnetic disk, optical disk, ROM, RAM, or other hardware storage medium. Such computer programs may also be received via network interface 1950, serial port interface 1942, or any other interface type. Such computer programs, when executed or loaded by an application, enable computing device 1900 to implement features of embodiments discussed herein. Accordingly, such computer programs represent controllers of the computing device 1600.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### V. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method in a computing device in a communication system, comprising:
receiving, from a host user device operated by an event host, an event indication corresponding to an event, the event indication including event details that include at least an event location;
determining a list of potential guests for the event from a plurality of users;
transmitting event information containing at least a portion of the event details to users in the list of potential guests to enable each user in the list of potential guests to access the event information on a respective guest user device;
receiving one or more reservation requests from guest user devices of one or more users in the list of potential guests in response to the transmitted event information;
transmitting the one or more reservation requests to the host user device;
receiving from the host user device one or more indications by the event host of acceptances or rejections of each of the one or more reservation requests; and
determining a list of booked guests to include one or more users from the list of potential guests based at least in part on the received indications of acceptances or rejections.

2. The method of claim 1, further comprising:
transmitting a booking indication to each user in the list of booked guests.

3. The method of claim 1, further comprising:
receiving from the event host:
an event closed indication, or
an event cancellation indication.

4. The method of claim 1, wherein said determining a list of potential guests for the event comprises:
receiving a posting preference of private from the host user device; and
limiting inclusion in the list of potential guests to users in a host guest list of the event host.

5. The method of claim 4, further comprising:
determining the host guest list of the event host by:
receiving one or more inclusion requests from users at respective user devices to be included in the host guest list of the event host;
transmitting the one or more inclusion requests to the host user device;
receiving from the host user device one or more indications by the event host of acceptances or rejections of each of the one or more inclusion requests; and
determining the host guest list of the host to include users with indicated acceptances to their inclusion requests.

6. The method of claim 4, further comprising:
determining the host guest list of the event host by:
receiving one or more inclusion requests from the host user device;
transmitting the one or more inclusion requests to corresponding one or more user devices of the one or more users;
receiving from the one or more user devices one or more indications of acceptances or rejections of the one or more inclusion requests; and
determining the host guest list of the event host to include users from which indicated acceptances were received.

7. The method of claim 1, wherein said determining a list of potential guests for the event comprises:
receiving from the host user device a posting preference of public; and
including all of the plurality of users in the list of potential guests.

8. The method of claim 1, further comprising at least one of:
transmitting a calendar appointment for the event to a guest user device of a user in the list of booked guests and to the host user device.

9. The method of claim 1, further comprising:
enabling users in the list of booked guests to contact the event host.

10. The method of claim 1, further comprising at least one of:
enabling the event host to rate a user in the list of booked guests who attended the event; or
enabling the user who attended the event to rate the event host who hosted the event.

11. The method of claim 1, wherein said transmitting event information comprises:
transmitting event information corresponding to a plurality of events associated with at least one additional event host to each user in the list of potential guests.

12. The method of claim 1, wherein the event information does not include the event location.

13. A computing device in a communication system, comprising:
at least one processor; and
a memory that stores program code configured to be executed by the at least one processor circuit code including:
first computer code configured to receive an event indication of an event configured by an event host interacting with a host user interface at a host user device to provide event details, the event indication including the event details, and determine a list of potential guests for the event from the plurality of users;
second computer code configured to transmit event information containing at least a portion of the event details to the users in the list of potential guests, receive one or more reservation requests from one or more guest user devices of users in the list of potential guests in response to the transmitted event information, and transmit the one or more reservation requests to the host user device;
third computer code configured to receive indications of acceptances or rejections of each of the one or more reservation requests from the event host, and determine a list of booked guests to include one or more users from the list of potential guests based at least in part on the received indications of acceptances or rejections.

14. The computing device of claim 13, wherein the second computer code is further configured to transmit a booking indication to each user of the list of booked guests.

15. The computing device of claim 13, further comprising:
fourth computer code configured to receive from the event host:
an event closed indication, or
an event cancellation indication.

16. The computing device of claim 13, wherein to determine the list of potential guests for the event, the second computer code is further configured to:
receive a posting preference of private from the host user device; and
limit inclusion in the list of potential guests to users in a host guest list of the event host.

17. The computing device of claim 13, wherein to determine the list of potential guests for the event the second computer code is further configured to:
receive from the host user device a posting preference of public; and
include all of the plurality of users in the list of potential guests.

18. The computing device of claim 13, wherein the program code further comprises:
fifth computer code configured to:
transmit a calendar appointment for the event to a guest user device of a booked guest and to the host user device.

19. The computing device of claim 13, wherein the second computer code is further configured to enable booked guests to contact the event host.

20. The computing device of claim 13, wherein the host user device includes a host user interface configured to enable the event host to rate a user in the list of booked guests who attended the event; and
wherein a guest user device includes a guest user interface configured to enable the user who attended the event to rate the event host who hosted the event.

21. The computing device of claim 13, wherein the event information does not include the event location.
